(19) United States
(12) Patent Application Publication
(10) Pub. No.: US 2011/0227327 A1
(43) Pub. Date: Sep. 22, 2011

(54) Privacy card cover

(76) Inventor: Bryan Prichard, Frederick, MD (US)

(21) Appl. No.: 12/659,640

(22) Filed: Mar. 16, 2010

(51) Int. Cl. B42D 15/00

(52) U.S. Cl. 283/72

(57) ABSTRACT

A privacy card cover includes a front part and back part to hide information on a card. The privacy card cover is attachable and detachable from the card and is placed on the card by a user. The privacy card cover includes privacy film that prevents viewing of the information on the card except at an angle substantially perpendicular to the surface of the card. Different configurations of the privacy card cover allow any type of card to be covered. If the card includes a magnetic strip or other machine-readable data, then that part of the card is left uncovered and accessible.

### FIELD OF THE INVENTION

The present invention relates to a privacy card cover having a structure that attaches or covers a card to keep information on the card hidden. More particularly, the present invention relates to a privacy card cover having a structure that includes privacy film to prevent unauthorized viewing of a card.

### DISCUSSION OF THE RELATED ART

Credit and debit card fraud is a prevailing fear among consumers as identity theft incidents rise. In short, criminals can view a card in a store by standing near a customer. A phone camera or other such device may take a photo of the card to learn its number, name of user and expiration date. Using this information, a criminal may make unauthorized purchases or drain accounts.

Various safeguards strive to prevent unauthorized access to card information, such as privacy screen over equipment to enter pin numbers. These measures, however, prevent seeing a pin number being entered on a keypad and does not hide the information on the card. Moreover, sales people usually take the card and hold it while a purchase is being made. The sales people do not attempt to keep the information hidden from others and may place the card down while the customer searches for her wallet or grabs her purchases. Although brief, this time is more than enough for a dishonest salesperson or criminal to view the information needed.

Credit, debit, gas, bonus, frequent user and other such cards may be at risk from identity theft. Most customers carry several cards that are used daily for purchases. Further, most adults carry more than one card used for identification purposes, such as a driver's license, a military identification card, a residency card or a worker identification card. All of these items contain private information that could be used by a third party for criminal activity or identity theft.

### SUMMARY OF THE INVENTION

The disclosed embodiments of the present invention relate to a privacy card cover that eliminates the ability of unwanted parties to read and steal information from a card while it is exposed. The body or structure of privacy card cover does not impact usage or functionality of the card. The disclosed embodiments apply to all cards displaying information valuable to the card user.

The privacy card cover includes a privacy film or a tinted film that distorts, darkens, or blackens the portion of the card that it covers when viewed from an angle. In other words, the information on the card is readable only when viewed at an angle substantially perpendicular to the card surface. Thus, someone holding the card can read its information but one to the side may not.

The user applies the privacy card cover to the card or inserts the card to protect against identity theft and credit card theft. The privacy card cover is attachable and detachable from the card as needed. The privacy card cover allows information not readable to the naked eye to be accessible to magnetic strip readers and the like. Thus, the user may swipe the card for a purchase without having to remove the privacy card cover. The privacy card cover may include different patterns for the privacy film to darken the information on the card.

According to embodiments of the present invention, a privacy card cover is disclosed. The privacy card cover includes a structure attachable to a card. The structure comprises a front part and a back part. The structure includes a privacy film that renders information on a card viewable only at a substantially perpendicular angle. The privacy card cover also includes the back side having an aperture to expose a magnetic strip on the card. The privacy card cover also includes at least one attachable means on the front side or on the back side of the structure.

Further according to embodiments of the present invention, another privacy card cover is disclosed. The privacy card cover includes a front part including a privacy film to cover information on a card. The information is viewable at an about perpendicular angle to the privacy film. The privacy card cover also includes a back part including the privacy film. The back part includes an aperture located approximately over a machine-readable strip on the card. The front part and the back part are attachable to the card or to each other.

Another privacy card cover is disclosed. The privacy card cover includes a front part having a privacy film that renders information on a card unreadable except at an angle substantially perpendicular to the privacy film. The privacy card cover also includes a back part having the privacy film, wherein the privacy film leaves a machine-readable portion of the card exposed.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIGS. 1A-C illustrates a privacy card cover according to the disclosed embodiments.

FIGS. 2A-B illustrates another privacy card cover according to the disclosed embodiments.

FIGS. 3A-C illustrates another privacy card cover according to the disclosed embodiments.

FIGS. 4A-B illustrates another privacy card cover according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

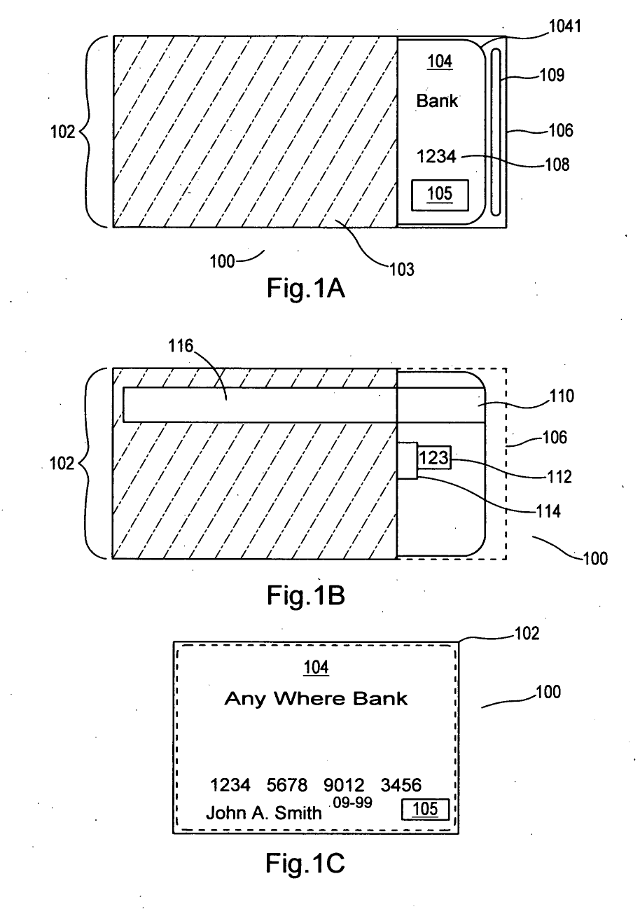

FIG. 1A depicts the front part of a privacy card cover 100 according to the disclosed embodiments. Privacy card cover 100 holds card 104. Card 104 may be inserted into privacy card cover 100, wherein privacy card cover 100 acts as a sleeve over card 104. Unlike known card sleeves, however, privacy card cover 100 allows information on card 104 to be viewed at the appropriate angle by a user.

Privacy card cover 100 includes structure 102 which supports privacy film 103. Privacy film 103 limits the angles at which a user can read the information on card 104. Referring to FIG. 1A, this information may include card numbers 108, logo 105 and the like. Logo 105 may identify a bank, card service or other information of interest. Privacy film 103 may comprise a light transmissive, polymeric base sheet made of material having different surfaces formed to prevent viewing underneath the sheet except from substantially directly perpendicular to card 104. Privacy film 103 also may include light directing elements formed in a pattern on structure 102.

The light directing elements may be represented by a pattern in FIG. 1A. The pattern for privacy film 103 is not limited by the pattern shown and may include any pattern that prevents unwanted viewing of card 104. Preferably, light directing elements are continuous over privacy film 103. The light directing elements may taper off at the ends of privacy card cover 100. Alternatively, structure 102 may include a small border along the edges of structure 102 that does not include the light directing elements.

Structure 102 also includes a flap 106 that folds over the end of card 104. Preferably, flap 106 extends from a back part of structure 102. Flap 106 may fold over the front of structure 102 to enclose card 104. Flap 106 includes attachable means 109, which secures flap 106 to the front of structure 102. Attachable means 109 may include any variety of adhesive material that secures flap 106. Attachable means 109 preferably is a re-adherable strip of adhesive that allows flap 106 to be attached and detached a plurality of times. Attachable means 109 also may have low-tack adhesive properties that does not leave a residue or marking on the front part of structure 102. Alternatively, attachable means 109 may include glue, permanent adhesive materials, and the like or even a small strip of material that hooks itself to structure 102.

FIG. 1B depicts a back part of privacy card cover 100 according to the disclosed embodiments. Structure 102 includes the back part and it is connected to the front part along the edges except for the edge opposite flap 106. The back part of structure 102 is distinguishable from the front part as it includes aperture 116. Aperture 116 allows a portion of card 104 to be visible to the naked eye from any angle. Preferably, the only portion of card 104 uncovered by aperture 116 is magnetic strip 110. Magnetic strip 110 is known in the art and contains information readable by the corresponding equipment that is not visible to the naked eye. Magnetic strip 110 also may be known as a machine-readable strip that transmits information about the card to a computer-related device that stores or uses the information in a transaction. Thus, magnetic strip 110 may remain exposed by privacy card cover 100 without revealing any discernable information.

Other features of card 104, however, remain hidden by privacy card cover 100. In other words, privacy film 103 of structure 102 hides information on card 104 from indirect view. For example, card 104 includes signature block 114 and security code 112. The placement and configuration of these features may differ from card to card, but most cards include a place for a user to sign and additional codes for use in electronic transactions. Most users do not want this information viewable or for third parties to see how the user signs documents.

The back part also includes flap 106 attached along its edge. Flap 106 may not include aperture 116. As noted above, flap 106 folds over the front part of structure 102. As shown in FIG. 1C, privacy card cover 100 fits over card 104 when flap 106 is folded over to attach to the front part. Structure 102 may be substantially rectangular to fit the card. Structure 102 should allow card 104 to fit snugly within privacy card cover 100. FIG. 1C also shows the view of card 104 from a substantially perpendicular angle. Pertinent information is viewable, such as card number, name, expiration date, bank, and the like. Should card 104 and privacy card cover 100 be tilted at an angle, then none of this information is viewable. Thus, a user or a store employee may see this information when looking directly at card 104.

The dimensions of privacy card cover 100 allow card 104 to be used with card readers or stored in a wallet. The size and shape, for example, of credit cards are defined under the International Standard ISO/IEC 7810:2003. This standard describes the physical standards for various types of identification cards. Under the ID-1 format, applicable cards carry an approximate dimension of 85.60 millimeter by 53.98 millimeter or 3.370 inches by 2.125 inches. These applicable cards include debit cards, automated teller machine cards, credit cards and the like.

Another important feature of cards defined under these standards pertains to the edge of the card. Referring to FIG. 1A, card 104 includes edge 1041. Most transactional cards, such as credit cards, do not have jagged edges, but are rounded. According to the referenced standards, the rounded corners may have a radius of about 3.18 millimeters. Further, under ISO/IEC 7813, cards should have a thickness of about 0.76 millimeters.

Thus, privacy card cover 100 includes dimensions to fit the parameters defined by the standards. Preferably, privacy card cover 100 includes a length of about 100 millimeters and a width of about 55 millimeters. These dimensions should enclose card 104, or provide a pocket within structure 102 to fit card 104. The thickness of privacy film 103 of structure 102 is such that card 104 is protected from wear and tear, but does not limit functionality.

Privacy card cover 100 may come partially assembled and placed over the card. Further, structure 102 may not include flap 106, and, instead just have a pouch configuration to hold card 104. Flap 106 also is not limited to extending from the back part of structure 102. Flap 106 may extend from any part or edge of structure 102. For example, a flap may extend from a top of the front or back part of structure 102 and attaches itself at the bottom of the part opposite the flap.

Alternatively, privacy card cover 100 may not include a flap 106. A user may insert card 104 through an opening at one end of structure 102, like a pouch. Attachable means 109 may be within the pouch to close it to prevent card 104 from falling out. In addition, a clasp or other securing means may be used to close the opening.

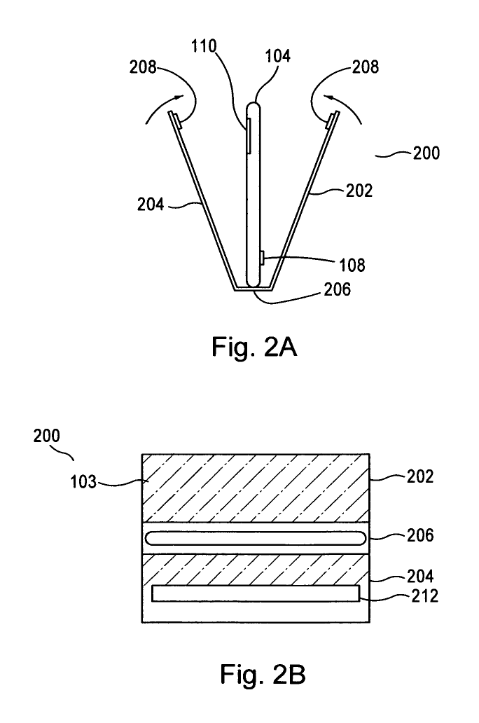

FIG. 2A depicts a side view of another privacy card cover 200 and card 104 according to the disclosed embodiments. Privacy card cover 200 differs from privacy card cover 100 in that it does not enclose card 104. Privacy card cover 200 folds over card 104 to fully cover the card except for magnetic strip 110 and a top part of card 104.

As shown in FIG. 2A, card 104 includes account numbers 108, which indicates the front of card 104, and magnetic strip 110, which indicates the back of card 104. The other features of card 104 disclosed above also are applicable here.

Privacy card cover 200 includes front part 202, back part 204 and bottom portion 206. Bottom portion 206 couples front part 202 and back part 204. Attachable means 208 attaches front part 202 and back part 204 to card 104. Attachable means 208 secures privacy card cover 200 to the top of the front and back of card 104. Preferably, attachable means 208 contacts back part 204 above magnetic strip 110. Attachable means 208 is comparable to attachable means 109 disclosed in FIG. 1A.

FIG. 2B depicts a top view of privacy card cover 200 and card 104 according to the disclosed embodiments. Privacy card cover 200 includes privacy film 103 that covers the front of card 104. Aperture 212 in back part 204 allows access to magnetic strip 110 for transactions or operations by magnetic readers, much like aperture 106 in FIG. 1B.

Although shown with bottom portion 206, privacy card cover 200, alternatively, may include a top portion to join front part 202 and back part 204. Aperture 212 would be located closer to the top portion than it is to bottom portion 206. Attachable means 208 may stay in the same location and just attach to the bottom of card 104.

Privacy card cover 200 may not be as large as privacy card cover 100 as it does not cover card 104 in its entirety. Further, privacy card cover 200 may avoid the need for edges or borders as front part 202 and back part 204 are attached on one side, such as bottom portion 206. Preferably, privacy card cover 200 includes a length of about 86 millimeters and a width or height of about 55 millimeters to apply to credit cards, debit cards, bank cards, rewards cards and the like. Bottom portion 206 may have a width of about 0.8 millimeter to secure card 104. Of course, privacy card cover 200 may vary in length and width depending on the type of card 104.

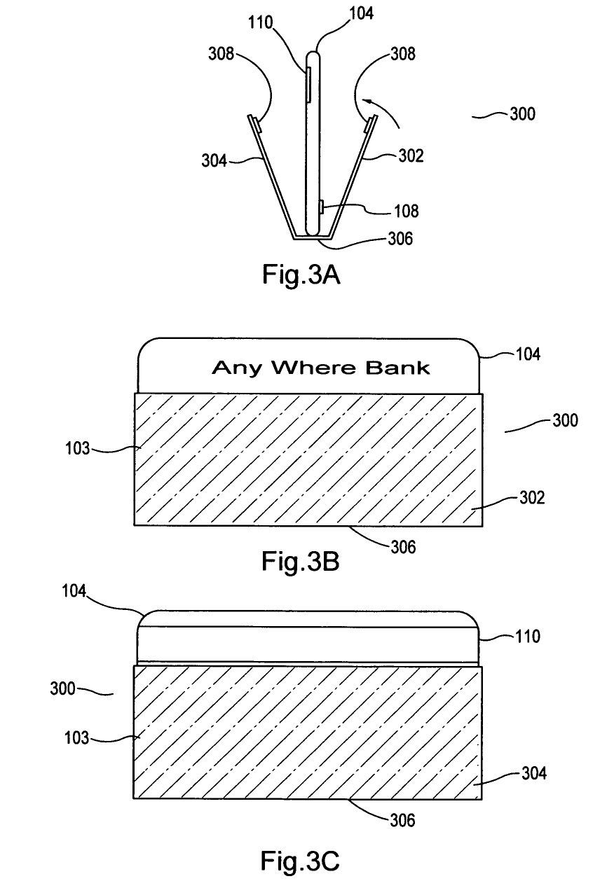

FIG. 3A depicts a side view of another privacy card cover 300 and card 104 according to the disclosed embodiments. Card 104 includes account numbers 108 and magnetic strip 110. Privacy card cover 300 covers information of value but does not completely cover all of card 104.

Privacy card cover 300 includes front part 302 and back part 304 coupled by bottom portion 306. Privacy card cover 300 also includes attachable means 308. Attachable means 308 secures front part 302 and back part 304 to card 104 but will partially cover the information. For example, privacy card cover 300 may cover account numbers 108, name and expiration date on the front of card 104 and information up to magnetic strip 110 on the back of card 104.

FIG. 3B depicts the front of privacy card cover 300 and card 104 according to the disclosed embodiments. FIG. 3B shows front part 302, bottom portion 306 and privacy film 103. Privacy film 103 prevents viewing of information from card 104 except when viewed substantially perpendicular. The top portion of card 104 is visible and not covered by privacy card cover 300.

FIG. 3C depicts the back of privacy card cover 300 and card 104 according to the disclosed embodiments. Back part 304 of privacy card cover 300 leaves magnetic strip 110 uncovered for ease of use. Privacy film 103 also is within back part 304 to hide signature blocks and security codes.

Dimensions for privacy card cover 300 are comparable to those of privacy card cover 200, except for a width or height of about 40 millimeters for front part 302 and back part 304. Bottom portion 306 may be about 0.8 millimeters in width.

Alternatively, privacy card cover 300 may be connected by bottom portion 306 and side portions between front part 302 and back part 304. Thus, privacy card cover 300 acts as a pouch to hold card 104. In this embodiment, attachable means 308 may not be needed as card 104 fits securely in privacy card cover 300 and the lengths and widths may be adjusted accordingly.

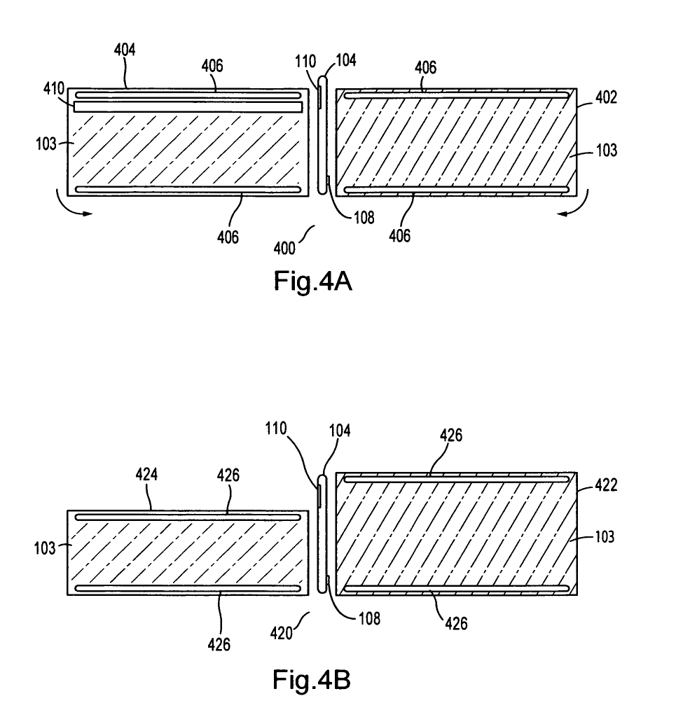

FIG. 4A depicts another privacy card cover 400 and card 104 according to the disclosed embodiments. Privacy card cover 400 differs from the other disclosed embodiments in that it has two separate pieces. Front part 402 attaches to the front of card 104 so as to cover account numbers 108 and other information. Back part 404 attaches to the back of card 104 to cover information while exposing magnetic strip 110. Front part 402 and back part 404 include privacy film 103 to prevent unauthorized viewing of information on card 104.

Back part 404 includes aperture 410, which allows magnetic strip 110 to be read during business transactions. Back part 404 also includes attachable means 406 above aperture 410 and at the bottom to secure it to card 104. Front part 402 also includes attachable means 406 on its top and bottom. Attachable means 406, however, may be located anyplace on front part 402. Each part preferably includes two attachable means 406.

Dimensions for privacy card cover 400 differ from the other card covers disclosed above. Privacy card cover 400 may include a length of about 85.60 millimeters and a width or height of about 53.98 millimeters for front part 402 and back part 404. In other words, front part 402 and back part 404 are about the same size.

FIG. 4B depicts another privacy card cover 420 and card 104 according to the disclosed embodiments. Privacy card cover 420 differs from privacy card cover 400 in that its back part 424 secures itself just below magnetic strip 110. Privacy card cover 420 includes front part 422 having attachable means 426. Back part 424 also includes attachable means 426 but does not have an aperture as magnetic strip 110 is left uncovered. Front part 422 and back part 424 include privacy film 103.

Dimensions for privacy card cover 420 may vary as it should cover those portions of card 104 that a user wants to keep private. Preferably, privacy card cover 420 has a length of about 85.60 millimeters for front part 422 and back part 424. Front part 422 may include a width or height of about 53.98 millimeters while back part 424 may include a width or height of about 40 millimeters. These dimensions also may be adjustable depending on the type of card 104.

Thus, the disclosed embodiments pertain to privacy card covers that incorporate privacy film to prevent identity theft or unauthorized viewing of the information on a card. A privacy card cover according to the disclosed embodiments is separate from the card itself. The privacy card cover is an aftermarket item to be purchased and attached to a card.

Using the privacy film, a privacy card cover blacks out or darkens the portion of the card covered from viewing except directly from above the surface of the card. A user or salesperson may hold the card until the information is viewable. One to the side or at angle may not view the information due to the privacy card cover. Cameras from above, a well-known method of identity theft, may not capture and store the information on the card.

The privacy card cover, however, maintains the functionality of the card by allowing the magnetic strip to be read. The user does not have to remove the card from the privacy card cover. Thus, the information is kept hidden even during transactions in public.

The privacy card covers disclosed above included apertures or dimensions that left a magnetic strip uncovered for use. The disclosed embodiments are not limited to the configurations shown and may include one or more apertures either in the front part or the back part of a privacy card cover. Preferably, these apertures allow information to be read by a machine, device, scanner and the like from the card that is not recognizable to the naked eye. Thus, leaving these portions uncovered does not impede the security aspects of the present invention. Further, the privacy card cover may include differing dimensions and configurations to leave parts of card 104 uncovered as needed.

It will be apparent to those skilled in the art that various modifications and variations can be made in the disclosed embodiments of the privacy card cover without departing from the spirit or scope of the invention. Thus, it is intended that the present invention covers the modifications and variations of the embodiments disclosed above provided that the modifications and variations come within the scope of any claims and their equivalents.

What is claimed is:

1. A privacy card cover comprising:
a structure attachable to a card, the structure comprising a front part and a back part, wherein said structure includes a privacy film that renders information on a card viewable only at a substantially perpendicular angle;
the back side having an aperture to expose a magnetic strip on the card; and
at least one attachable means on the front side or on the back side of the structure.

2. The privacy card cover of claim 1, wherein the front part and the back part of the structure are connected by a bottom portion.

3. The privacy card cover of claim 1, further comprising a flap extending from the back part, wherein the flap includes the attachable means.

4. The privacy card cover of claim 3, wherein the flap folds over the front part to enclose the card.

5. The privacy card cover of claim 1, wherein the front part of the structure includes an area about equal to an area of the back part.

6. The privacy card cover of claim 1, wherein the back part includes an area less than an area for the front part.

7. The privacy card cover of claim 1, wherein the front part and the back part are separated from each other.

8. The privacy card cover of claim 1, wherein the structure forms a cavity in which to insert the card.

9. The privacy card cover of claim 1, wherein the structure is applicable to cover a credit card, a debit card, a driver's license, military identification card, a student identification card, store card, work identification card or a health identification card.

10. A privacy card cover comprising:
a front part including a privacy film to cover information on a card, wherein the information is viewable at an about perpendicular angle to the privacy film;
a back part including the privacy film, wherein the back part includes an aperture located approximately over a machine-readable strip on the card;
the front part and the back part are attachable to the card or to each other.

11. The privacy card cover of claim 10, further comprising a bottom portion connecting the front side to the back side.

12. The privacy card cover of claim 10, wherein the front part is greater in area than the back part.

13. The privacy card cover of claim 10, wherein the front part and the back part are connected on all but one side to enclose the card.

14. A privacy card cover comprising:
a front part having a privacy film that renders information on a card unreadable except at an angle substantially perpendicular to the privacy film; and
a back part having the privacy film, wherein the privacy film leaves a machine-readable portion of the card exposed.

15. The privacy card cover of claim 14, further comprising a top portion or a bottom portion coupling the front part and the back part.

16. The privacy card cover of claim 14, further comprising an aperture located in the back part to expose the machine-readable portion.
